(19) United States
(12) Patent Application Publication
(10) Pub. No.: US 2025/0026935 A1
(43) Pub. Date: Jan. 23, 2025

(54) VINYL ARTICLES WITH IMPROVED SOLAR REFLECTIVITY

(71) Applicants: Rohm and Haas Company, Collegeville, PA (US); Dow Global Technologies LLC, Midland, MI (US)

(72) Inventors: Yuanqiao Rao, Berwyn, PA (US); Ian J. Drake, Conshohocken, PA (US); Xindi Yu, Paoli, PA (US)

(21) Appl. No.: 18/709,114

(22) PCT Filed: Nov. 17, 2022
(86) PCT No.: PCT/US2022/050173

§ 371 Date: May 10, 2024

Related U.S. Application Data
(63) Continuation of application No. 63/280,324, filed on Nov. 17, 2021.

(51) Int. Cl. C09D 5/33; C08J 7/04

(52) U.S. Cl. CPC C09D 5/004; C08J 7/042; C08J 2333/12; C08J 2369/00; C08J 2427/06

(57) ABSTRACT

A vinyl article comprises a vinyl substrate and an infrared reflective film disposed on the vinyl substrate. The infrared reflective film has a reflectivity greater than 30% for wavelengths between 800 to 1000 nm and a transmittance greater than 60% for wavelengths between 400 to 700 nm. A process for producing the vinyl article is also disclosed.

### FIELD OF THE INVENTION

The invention relates to vinyl articles having improved solar reflectivity.

### BACKGROUND

Vinyl articles, particularly vinyl substrates exposed to sunlight such as vinyl siding and trim, often suffer from defects due to the solar radiation. For example, a common defect in vinyl sidings is called “oil canning”. Oil canning is manifested in appearance of surface bulges, waves and ripples in the vinyl plank while in use. The oil canning is caused by the temperature rise due to solar radiation.

One attempt to minimize oil canning is to add a white pigment to the vinyl plank because the white pigment can scatter the solar radiation and reduce the generated heat. Such a technique is disclosed, for example, in U.S. Patent Application Publication No. 2012/0052317. However, the addition of white pigment can have several shortcomings. One issue is the inability of the white pigment to scatter enough sunlight in high temperature regions. Many white pigments designed to scatter visible light do not scatter near infrared (NIR) effectively. Additionally, white pigments cannot be used for vinyl siding in darker tones.

Other attempts to minimize oil canning involve attempts to improve the heat distortion temperature and/or lower the coefficient of the thermal expansion of the vinyl siding.

Therefore, it is desirable to develop vinyl articles that have improved resistance to oil canning without the shortcomings of existing remedies.

### SUMMARY OF THE INVENTION

One aspect of the invention relates to a vinyl article comprising a vinyl substrate and an infrared reflective film disposed on the vinyl substrate. The infrared reflective film has a reflectivity greater than 30% for wavelengths between 800 and 1000 nm and a transmittance greater than 60% for wavelengths between 400 and 700 nm.

A further aspect of the invention relates to a process for producing a vinyl article comprising providing a vinyl substrate, and laminating an infrared reflective film on the vinyl substrate. The infrared reflective film has a reflectivity greater than 30% for wavelengths between 800 and 1000 nm and a transmittance greater than 60% for wavelengths between 400 and 700 nm.

### BRIEF DESCRIPTION OF THE DRAWINGS

FIG. 1 is an AFM image of an infrared reflective film according an embodiment of the invention.

FIG. 2 is a specular reflection spectrum of an infrared reflective film according to an embodiment of the invention.

### DETAILED DESCRIPTION OF THE INVENTION

The inventors have discovered that defects in vinyl articles due to solar radiation can be significantly reduced by adding a visually transparent film that is reflective in the near infrared (IR) range (i.e., IR reflective) to the vinyl article. Because 50% of the solar energy resides in the wavelength between 750 nm to 1200 nm, the IR reflective film can reflect sunlight and reduce the surface temperature of the vinyl article. This improvement can be achieved on vinyl article articles of all colors without significantly altering the appearance of the underlying vinyl substrate and without requiring alteration of the composition of the underlying vinyl substrate.

As used herein, the term “polymer” refers to a polymeric compound prepared by polymerizing monomers, whether of the same or a different type. The generic term “polymer” includes the terms “homopolymer,” “copolymer,” and “resin.” As used herein, the term “polymerized units derived from” refers to polymer molecules that are synthesized according to polymerization techniques wherein a product polymer contains “polymerized units derived from” the constituent monomers which are the starting materials for the polymerization reactions. As used herein, the term “(meth)acrylate” refers to either acrylate or methacrylate or combinations thereof, and the term “(meth)acrylic” refers to either acrylic or methacrylic or combinations thereof. As used herein, the term “substituted” refers to having at least one attached chemical group, for example, alkyl group, alkenyl group, vinyl group, hydroxyl group, carboxylic acid group, other functional groups, and combinations thereof.

As used herein, the term “weight average molecular weight” or “Mw” refers to the weight average molecular weight of a polymer as measured by gel permeation chromatography (“GPC”), for acrylic polymers against polystyrene calibration standards following ASTM D5296-11 (2011), and using tetrahydrofuran (“THF”) as the mobile phase and diluent. As used herein, the term “weight of polymer” means the dry weight of the polymer.

As used herein, when it is stated that “the polymer composition contains little or no” of a certain substance, it is meant that the polymer composition contains none of that substance, or, if any of that substance is present in the present composition, the amount of that substance is 1% or less by weight, based on the weight of the polymer composition. Among embodiments that are described herein as having “little or no” of a certain substance, embodiments are envisioned in which there is none of that certain substance.

Disclosed herein is a vinyl article comprising a vinyl substrate and an infrared reflective film disposed on the vinyl substrate.

Preferably, the vinyl substrate comprises a polyvinyl chloride (PVC) substrate. However, the composition of the vinyl substrate is not limited and may comprise any vinyl polymer known in the art. Preferably, the vinyl substrate is a plank of vinyl siding, architectural trim, or foamed vinyl substrates (e.g., PVC foam board used in decking material, fascia pergola, and other exterior building products).

The infrared reflective film has a reflectivity greater than 30% for wavelengths between 800 and 1000 nm, which comprises wavelengths in the near IR region. Preferably, the infrared reflective film has a reflectivity greater than 40% for wavelengths between 800 and 1000 nm. More preferably, the infrared reflective film has a reflectivity greater than 50% for wavelengths between 800 and 1000 nm. Even more preferably, the infrared reflective film has a reflectivity greater than 60% for wavelengths between 800 and 1000 nm. Reflectivity/transmittance is measured using a PerkinElmer Lambda 950 UV-Vis-NIR spectrometer and a 60 mm Integrated Sphere Accessory at a resolution (slit width) of 2 nm and a data interval of 2 nm. The detector response time was 0.2 sec and 8° of reflection/transmission data was collected.

In addition to the reflectivity in the near IR region, the infrared reflective film has a transmittance greater than 60% for wavelengths between 400 and 700 nm, i.e., the visible region. Preferably, the infrared reflective film has a transmittance greater than 70% for wavelengths between 400 and 700 nm. More preferably, the infrared reflective film has a transmittance greater than 80% for wavelengths between 400 and 700 nm.

Preferably, the thickness of the infrared reflective film ranges from 5 microns to 100 microns. For example, the thickness of the infrared reflective film may be at least 10 microns, at least 20 microns, at least 30 microns, or at least 40 microns, and the thickness of the infrared reflective film may be less than 100 microns, less than 90 microns, less than 80 microns, less than 70 microns, or less than 60 microns.

Preferably, the infrared reflective film comprises a first polymeric material having a refractive index, n1, and a second refractive index, n2. The refractive index contrast, n1/n2, is preferably greater than 1.04. More preferably, the refractive index contrast is greater than 1.05. Even more preferably, the refractive index contrast is greater than 1.06.

Preferably, the first polymeric material has a refractive index, n1, greater than 1.5. Examples of the first polymeric material include, but are not limited to, polycarbonate, polyethylene naphthalate, polystyrene, polyethylene terephthalate, polysulfone, polyamide, cyclic polyolefins, polyvinyl chloride, polyvinylidene chloride. Preferably, the first polymeric material comprises polycarbonate, which has a refractive index of 1.58.

Preferably, the second polymeric material has a refractive index, n2, less than 1.5. Examples of the second polymeric material include, but are not limited to, poly(methyl methacrylate), polyvinylidene fluoride, and polyethylene oxides. Preferably, the second polymeric material comprises poly(methyl methacrylate), which has a refractive index of about 1.49.

Preferably, the first polymeric material of the infrared reflective film comprises polycarbonate and the second polymeric material comprises poly(methyl methacrylate), such that the infrared reflective film has a refractive index contrast (n1/n2) of about 1.06.

Preferably, infrared reflective film comprises a plurality of alternating layers of the first polymeric material and the second polymeric material. Each of the alternating layers may have an average thickness ranging from 100 to 250 nm, preferably from 110 to 225 nm, and more preferably from 120 to 200 nm. As defined herein, the “average thickness” of the layers means the arithmetic mean of all of the layers in the infrared reflective film is between the stated range. Preferably, each layer in the infrared reflective film has a thickness variation of less than 50% of the average thickness of all of the layers.

The infrared reflective film preferably comprises 50 to 400 alternating layers of the first and second polymeric materials, i.e., 25 to 200 layers of each of the materials.

Another aspect of the present invention relates to a process for producing a vinyl article. The process comprises providing a vinyl substrate and laminating an infrared reflective film, as described above, on the vinyl substrate. As used herein, the term “providing a vinyl substrate” means that a vinyl substrate is produced or acquired for use in the process, but does not require the vinyl substrate to be produced by the method. For example, a vinyl substrate may be produced and shipped to the location where the infrared reflective film is laminated onto the vinyl substrate. The term “laminating” means that the infrared reflective film is bonded to the vinyl substrate, such as, for example, using an adhesive.

In the process of the invention, the infrared reflective film may be prepared, for example, by extrusion. First and second polymeric materials may be coextruded to form an infrared reflective film comprised of alternating layers. The extruded film may be cooled down on a chill roll to form the infrared reflective film.

To laminate the infrared reflective film to the vinyl substrate, the infrared reflective film may be adhered to a surface of the vinyl substrate. An appropriate adhesive, such as, for example, a water borne acrylic binder adhesive, can be used to adhere the infrared reflective film to the vinyl substrate.

### Examples

### Fabrication and Measurement of the Infrared Reflective Film

Calibre 200-14 NA natural resins (MFI=14 dg/min, 300° C./1.2 kg) were obtained from Trinseo, LLC. Plexiglas V045-100 (MFI=2.3 dg/min, 230° C./3.8 kg) was received from Arkema Inc. The polycarbonate (PC) and poly(methyl methacrylate) (PMMA) resins were dried in a drier at 120 and 80° C. overnight to reduce the moisture content before processing.

A coextrusion line was utilized for the microlayer extrusion trial and consisted of two 31.75 mm (1.25 inch) diameter, 24:1 L/D single screw extruders. The extruders fed individual gear pumps to ensure uniform flow of the polymer melts to the feed block and dies. A precision feedring was used to produce layered coextruded structures with 100 or 200 layers. They were merged with skin layers (50% by volume) and extruded at 20 lb/h from an 8-inch wide film die to 12-50 micron thick films. Extruder and die temperatures were set at 243° C. Extruded films were cooled down on a chill roll set at 104° C.

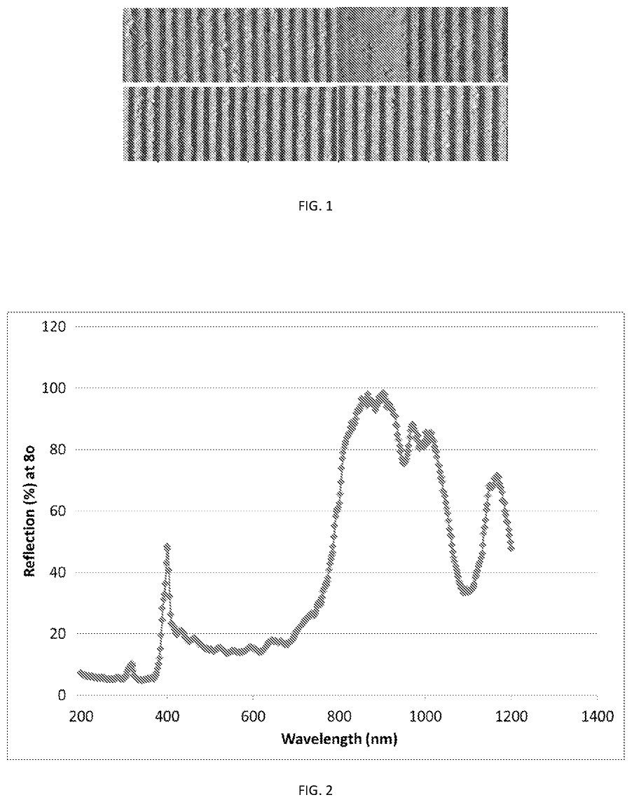

Cross-sectioned multilayer film samples were prepared by punching specimens out of samples and mounting them in vice holders. Samples were milled flat with a cryo-mill at about −80° C. The samples were then polished with cryomicrotomy at −80° C. The block faces were examined. Peak force tapping AFM images were obtained on a Bruker Icon using a Nanoscope V controller (software v 8.15). The cantilevers used were NanoWorld Arrow NCR with the settings outlined in AL-2016-005591. All images were captured at 1024 lines of resolution and produced with SPIP version 6.4.2. software. A second order average plane fit was used, with a zero order LMS and the mean set to zero. Layer measurements were performed in ImageJ. The average thickness of the PC layers was 163 nm and the average thickness of the PMMA layers was 152 nm. AFM images of an exemplary film are shown in FIG. 1.

A PerkinElmer Lambda 950 UV-Vis-NIR spectrometer and a 60 mm Integrating Sphere Accessory at a resolution (slit width) of 2 nm and data interval of 2 nm was used to measure the IR reflection. The detector response time was 0.2 sec. 8º reflection data was collected. FIG. 2 shows a specular reflection spectrum of an infrared reflective film according to an embodiment of the invention.

Solar Spectrum Reflectometer SSR-ER (Devices & Services Company) was used to measure the total solar reflectivity of the films. The comparative example is a 127 micron (5 mil) think clear impact resistant polycarbonate film (85585K102 from McMaster-Carr Co.) The total solar reflective result is summarized in Table 1.

TABLE 1

| Sample | Total Solar Reflectivity | |
|---|---|---|
| Exemplary film | 0.29 | (+/−0.01) |
| Comparative PC film | 0.094 | (+/−.001) |

As seen in Table 1, the infrared reflective film of the invention has significant solar reflectivity and is clear in the visible range.

### Thermal Heating Reduction Measurements

4 different vinyl siding products were acquired from Lowe's. They belong to the compass series made by Georgia-Pacific with a variety of dark colors, including Hearthstone Brown (Example 1), Redwood (Example 2), Pewter (Example 3), and Coastal Blue (Example 4). 2 samples of each color were glued to a 1 inch thick polystyrene foam substrate to essentially block all heat transfer underneath the sample.

2 samples of each product were glued to the substrate side by side. One sample served as the comparative example, and an infrared reflective film according to the invention was glued to the front surface of the other sample using a water borne acrylic binder adhesive. The adhesive appeared transparent at the thickness applied.

On a sunny day with occasional clouds, the sample panels were exposed to sunlight at horizontal and vertical orientations. The test were conducted between 11 am and 2 μm, where ambient temperature was around 30° C. Each exposure condition lasted ˜45 mins to allow a steady state to be reached. The horizontal orientation mimicked direct sunlight exposure, the worst case scenario in terms of solar heating. The vertical orientation mimicked glancing incidence, or an average exposure condition. Sample surface temperatures were measured by an FLIR TG167 thermal imaging thermometer. The results are shown below in Table 2.

TABLE 2

| | Horizontal | Vertical |
|---|---|---|
| Sample | Orientation (° C.) | Orientation (° C.) |
| Example 1 - Control | 63.9 | 52.5 |
| Example 1 - IR Film | 62.2 | 50.6 |
| Example 2 - Control | 66.1 | 53.6 |
| Example 2 - IR Film | 58.3 | 50.3 |
| Example 3 - Control | 63.9 | 51.3 |
| Example 3 - IR Film | 59.4 | 49.3 |
| Example 4 - Control | 65.6 | 51.1 |
| Example 4 - IR Film | 60.0 | 48.1 |

As can be seen in Table 2, the samples having the inventive infrared reflection films have a lower temperature than the control samples at the same sun exposure condition. The temperature of all the samples after sun exposure is less than 63° C. The temperature difference between the examples and comparative examples depends on the color (NIR spectrum included) of the vinyl product. The Product “Redwood” showed the largest temperature difference of 8° C. under direct sunlight exposure. The lowered temperature provided by the inventive infrared reflection films is expected to prevent the oil canning of PVC vinyl siding.

1. A vinyl article comprising:
a vinyl substrate, and
an infrared reflective film disposed on the vinyl substrate, wherein the infrared reflective film has a reflectivity greater than 30% for wavelengths between 800 and 1000 nm and a transmittance greater than 60% for wavelengths between 400 and 700 nm.

2. The vinyl article of claim 1, wherein the vinyl substrate comprises a polyvinyl chloride (PVC) resin.

3. The vinyl article of claim 1, wherein the infrared reflective film comprises a first polymeric material having a refractive index, n1, and a second polymer material having a refractive index, n2, wherein n1/n2 is greater than 1.04.

4. The vinyl article of claim 3, wherein the infrared reflective film comprises a plurality of alternating layers of the first polymeric material and the second polymeric material.

5. The vinyl article of claim 4, wherein each of the plurality of alternating layers of the first polymeric material and the second polymeric material has an average thickness ranging from 100 to 250 nm.

6. The vinyl article of claim 3, wherein the first polymeric material is selected from the group consisting of polycarbonate, polyethylene naphthalate, polystyrene, polyethylene terephthalate, polysulfone, polyamide, cyclic polyolefins, polyvinyl chloride, polyvinylidene chloride, and the second polymeric material is selected from the group consisting of poly(methyl methacrylate), polyvinylidene fluoride, and polyethylene oxides.

7. The vinyl article of claim 3, wherein the first polymeric material comprises polycarbonate and the second polymeric material comprises poly(methyl methacrylate).

8. The vinyl article of claim 4, wherein the infrared reflective film comprises 50 to 400 alternating layers of the first polymeric material and the second polymeric material.

9. The vinyl article of claim 1, wherein the infrared reflective film has a reflectivity greater than 40% for wavelengths between 800 and 1000 nm and a transmittance greater than 70% for wavelengths between 400 and 700 nm.

10. The vinyl article of claim 1, wherein the vinyl article comprises a plank of vinyl siding, architectural trim, or a foamed vinyl substrate.

11. A process for producing a vinyl article comprising:
providing a vinyl substrate; and
laminating an infrared reflective film on the vinyl substrate;
wherein the infrared reflective film has a reflectivity greater than 30% for wavelengths between 800 and 1000 nm and a transparency greater than 60% for wavelengths between 400 and 700 nm.

12. The process of claim 11, wherein the infrared reflective film is formed by coextruding a first polymeric material and a second polymeric material to form 50 to 400 alternating layers, and casting the formed layers on a chill roll to obtain the infrared reflective film.

13. The process of claim 12, wherein the first polymeric material has a refractive index, n1, and the second polymeric material has a refractive index, n2, wherein n1/n2 is greater than 1.04.

14. The process of claim 12, wherein the first polymeric material is selected from the group consisting of polycarbonate, polyethylene naphthalate, polystyrene, polyethylene terephthalate, polysulfone, polyamide, cyclic polyolefins, polyvinyl chloride, polyvinylidene chloride, and the second polymeric material is selected from the group consisting of poly(methyl methacrylate), polyvinylidene fluoride, and polyethylene oxides.

15. The process of claim 12, wherein each of the layers of the first polymeric material and the second polymeric material has an average thickness ranging from 100 to 250 nm.

16. The process of claim 11, wherein the infrared reflective film has a reflectivity greater than 40% for wavelengths between 800 and 1000 nm and a transmittance greater than 70% for wavelengths between 400 and 700 nm.

17. The process of claim 11, wherein the vinyl article comprises a polyvinyl chloride resin.

18. The process of claim 11, wherein the vinyl article comprises a plank of vinyl siding, architectural trim, or a foamed vinyl substrate.
